(19) United States
(12) Patent Application Publication
(10) Pub. No.: US 2006/0010226 A1
(43) Pub. Date: Jan. 12, 2006

(54) Controlling content communication in a communication system

(75) Inventors: Tuija Hurtta, Espoo (FI); Zhi-Chun Honkasalo, Kauniainen (FI); Risto Mononen, Espoo (FI); Omar Al-Janabi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/934,559

(22) Filed: Sep. 7, 2004

(30) Foreign Application Priority Data
Jul. 7, 2004 (FI) 20040944

(51) Int. Cl. G06F 15/16

(52) U.S. Cl. 709/217

(57) ABSTRACT

A method controls content communication between a communication device and another communicating party in a communication system. The method includes providing a first network entity with device information relating to the communication device. Furthermore, the method includes receiving in the first network entity content to be delivered to or from the communication device. Furthermore, the method includes controlling delivery of the content based on the communication device information. A network entity in a communication system is configured to execute the method.

### FIELD OF THE INVENTION

The invention relates to communication systems, and more particularly to controlling content communication between a communication device and another communicating party in a communication system.

### BACKGROUND OF THE INVENTION

A communication system can be seen as a facility that enables communication sessions between two or more entities such as a communication device or a user terminal and/or other nodes associated with the communication system. Users of a communication system may be offered and provided numerous services, such as two-way or multi-way calls, data communication or multimedia services or simply an access to a network, such as the Internet. Examples of communication systems may include fixed line communication systems, such as a public switched telephone network (PSTN), wireless communication systems, e.g. global system for mobile communications (GSM), general packet radio service (GPRS), universal mobile telecommunications system (UMTS), wireless local area network (WLAN) and so on, and/or other communication networks, such as an Internet Protocol (IP) network and/or other packet switched data networks. Various communication systems may simultaneously be concerned in a connection. Systems originally designed separate, like mobile communication systems and the IP systems, are becoming interoperable.

A user may access a communication network by means of any appropriate communication device or user terminal, such as user equipment (UE), a mobile station (MS), a cellular phone, a personal digital assistant (PDA) or the like, or other user terminal, such as a personal computer (PC), or any other device operable according to a suitable network protocol, such as a wireless applications protocol (WAP) or a hypertext transfer protocol (HTTP). The communication device may support, in addition to call and network access functions, other services, such as short message service (SMS), multimedia messaging service (MMS), electronic mail (email), Web service interface (WSI) messaging and voice mail.

An intelligent edge has been proposed for providing a network border with enhanced functions, such as authentication and authorization, Quality of Service (QoS), inter-operator service level agreements, pre-paid balance check and charging, and inappropriate traffic filtering. The intelligent edge may be an enhancement of appropriate network entities, such as a gateway GPRS support node (GGSN). New entities and functions may be added when needed. The intelligent edge may comprise service core functions, such as service aware packet connectivity, session control, dynamic subscription management registers and intelligent charging control. The service core functions may be complemented by service enablers, i.e. generic functionalities usable by subscriber applications to provide services. Multimedia messaging, mobile browsing, presence, location, delivery and streaming servers are examples of service enablers. Often a plurality of service enablers, for example a chain or a network of service enablers, may be needed for providing a service.

In a network, a subscriber information database may store subscription profiles of subscribers of the network. In the intelligent edge, the subscriber information database may often be referred to as a subscriber directory. A subscription profile may comprise information usable, for example, for authorization and policy control purposes. By authorization, it is possible to determine whether a subscriber is allowed to use an access point. Authorization may also inform which services are allowed within the access point. By policy control, it may be possible to set different kind of rules, e.g. charging rules, QoS rules, traffic filtering rules, rules for chained service selection and chained service component specific rules. Rules for chained service selection may define that chained services to be used are selected for an access bearer or service flow. For example, rules for chained service may define: “use Performance Enhancement Proxy (PEP) and Firewall (FW) for service flow XYZ”. The PEP is a non-limiting example of chained service components.

Applications and content relating to services offered in or via the communication systems are expanding. In particular, in the mobile domain, introduction of open mobile operating systems, such as Symbian and Java applications, enables increasing the amount and size of the applications and content, e.g. images. Malicious content and applications, such as viruses, may be assisted to spread out with an increasing amount of traffic. Increasing amount of features in communication devices, in particular in mobile terminals, may render the devices more vulnerable and help viruses and malicious code reaching the devices. For example, images exploiting weaknesses of an image decoder in a communication device may cause the device to crash or to work poorly. For example, a piece of code that is malicious for a certain mobile terminal may run fine for another terminal.

The MMS is one of the emerging mobile services and technologies for delivering different types of content and applications to mobile devices. Other methods, such as browsing and downloading, may be used for delivering contents and applications to mobile terminals. When delivering content and applications to a communication device, it might be desired to scan and/or inspect the content to protect the communication device against viruses or malicious and harming code. However, virus scanning and inspection of application and content is not well defined in respect of mobile terminals or other mobile communication devices. Some systems exist, where application and content inspection, for example virus scanning, may be performed using proprietary interfaces. In respect of the MMS messages, the virus scanning of the content or application is not commonly performed, as this would increase latency in delivering the message.

The expanding traffic in the network and increasing amount of different types of communication devices and network entities concerned in the communication may require improved solutions in controlling content communication.

### SUMMARY OF THE INVENTION

In accordance with an aspect of the invention, there is provided a method for controlling content communication between a communication device and another communicating party in a communication system. The method comprises providing a first network entity with device information relating to the communication device. Furthermore, the method comprises receiving in the first network entity content to be delivered to or from the communication device. Furthermore, the method comprises controlling delivery of the content based on the communication device information.

In accordance with a further aspect of the invention, there is provided a network entity in a communication system. The network entity is configured to obtain device information relating to a communication device, to receive content to be delivered to or from the communication device and to control delivery of the content based on the communication device information.

In accordance with a further aspect of the invention, there is provided a second network element, configured to collect and store communication device information and to provide the communication device information with a first network entity.

In accordance with a further aspect of the invention, there is provided a communication system configured to obtain device information relating to a communication device, to receive content to be delivered to or from the communication device and to control delivery of the content based on the communication device information.

In an embodiment, controlling may comprise decomposing the content into content elements and inspecting the content elements for suitability for the communication device. The content elements may be inspected for elements suspected to be malicious, undesirable, incompatible or virus for the communication device. In an embodiment, the elements suspected to be malicious, undesirable, incompatible or virus for the communication device may be stored in a network side storage. The content elements to be inspected may comprise elements of an application that is executable in the communication device. Examples may comprise a Java, Mobile Station Application Execution Environment or Visual Basic application or a Symbian, Intelligent Software Architecture, Windows, Smartphone, Binary Runtime Environment for Wireless or Linux application. Examples may also comprise elements of a multimedia or instant messaging, email or chat service message.

In an embodiment, controlling may comprise composing a deliverable content entity by including the content elements found to be suitable for the communication device in the step of inspecting.

In an embodiment, controlling may be performed simultaneously with an operation adapting the content to fit with capabilities of the communication device.

In an embodiment, controlling may comprise decomposing the content into content elements, inspecting the content elements for suitability for the communication device and modifying the content elements found to be non-suitable for the communication device to make the non-suitable content suitable for the communication device. A deliverable content entity may then be composed by including the content elements found to be suitable and the content elements modified into suitable for the communication device.

In an embodiment, the communication device may be informed about the inspection.

In an embodiment, controlling may comprise inspection of the content in association with the communication device information for authorizing a service or service policy controlling. In authorizing a service, it may be determined whether the communication device is allowed to use an access point or which services are allowed for the communication device within the access point. Service policy controlling may comprise deciding service control rules to be applied to the communication device.

In an embodiment, the device information may be received from signaling the International Mobile Station Equipment Identity and Software Version Number or the User-Agent or the User Agent Profile.

In an embodiment, the device information may be received from a second network entity. The second network entity may be one of a trusted terminal platform, a subscriber information database or the communication device.

### BRIEF DESCRIPTION OF THE DRAWINGS

The invention will now be described in further detail, by way of example only, with reference to the following examples and accompanying drawings, in which:

FIG. 1 shows an example of a system in which the embodiments of the invention may be implemented;

FIG. 2 shows a flow chart illustrating an embodiment of the invention; and

FIG. 3 shows a block diagram of an embodiment of the invention.

### DETAILED DESCRIPTION OF PREFERRED EMBODIMENTS

Content interoperability between terminals having different capabilities and specification may be improved or provided using content adaptation or content transcoding. The content adaptation or content transcoding refers to transformation and manipulation of content, such as image, audio, video and mark-up content, to suit desired terminal capabilities or specifications. An operation called content adaptation or content transcoding may be performed to fit content, such as an MMS message, to a receiving device. Content adaptation may comprise, for example, changing image size or format so that the receiving terminal is able to handle the image file. For the content adaptation, the content may be decomposed and elements of the content may be scanned. After scanning and adaptation the content may be re-composed again.

On the other hand, content may be inspected for predetermined elements that are considered undesirable or harmful to the terminal. Examples of such undesirable content may comprise, but are not limited to, Trojan horses (viruses and worms), unsolicited messages (spam) and adult content. Content screening is an action of blocking and possibly notifying the communication participants about the undesirable content.

Different services, such as chained service components, service enablers, content or application inspection and so on, may have different needs for data processing.

It has now been found that collecting device information relating to communication devices and using the device information in controlling content communication between a communication device and another communicating party may provide improved delivery of content to communication devices and improved use of network elements, to name some of the advantages.

It has been found that inspection or screening of content and/or an application, such as virus scanning, could be included as part of a network entity performing content adaptation. It has also been found that communication device information may be taken into account during the inspection of the content and/or application. Furthermore, it has been found that device information relating to a particular communication device may be collected and stored independently from actions of a user of the communication device. Capabilities and information of a receiving communication device may then be used to perform desired inspection or screening, such as virus scanning, inspection for spam content, code analysis, and so on, resulting in individualized or case- and terminal-specific inspection. Network entities may benefit from knowing capabilities or other information on a communication device. A PEP is one non-limiting example of such a network entity. The PEP may be able to perform content adaptation based on the communication device information. If different types of PEPs are available, the PEP to be used may be selected based on the communication device information.

In the following, a term content is used in general to refer to content, applications, data, messages, and so on, which may be send in a communication systems from one node or device to another.

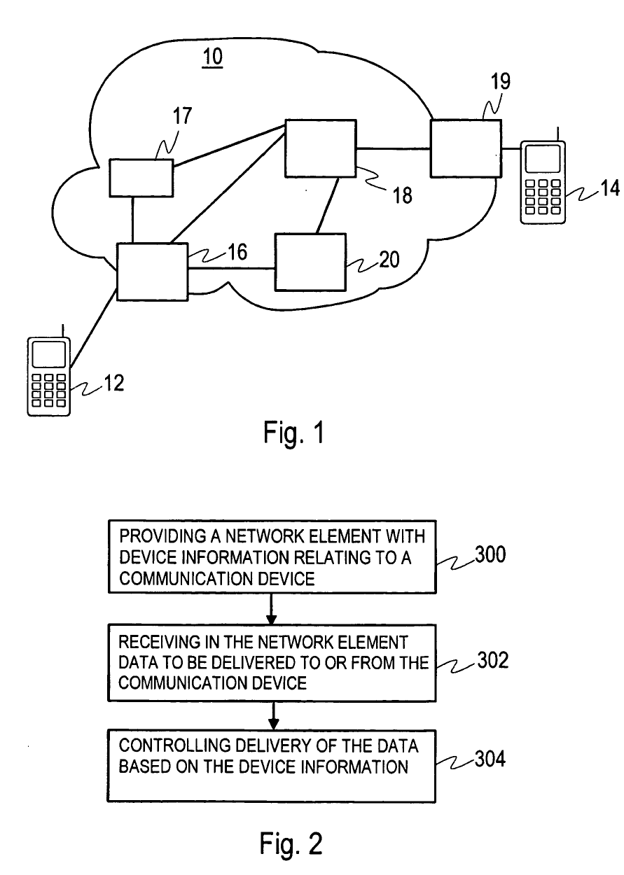

FIG. 1 shows an example of a system in which the embodiments of the invention may be implemented. A communications network 10, such as a mobile communications network, may be used for communication between a sending device 12 and a receiving device 14. The sending and the receiving device may be an appropriate communication device, such as a mobile terminal or the like. The sending and the receiving device may use different platforms, such as Symbian and Java, and applications such as the MMS, SMS and so on.

A sending device 12 may access the communications network 10 via an access point or a gateway node 16, such as a GGSN or an intelligent edge. Content to be sent from the sending device 12 to the receiving device 14 may be directed via a switching node 18 or another service in the network, such as a multimedia messaging service center (MMSC), a portal, a multimedia album, a downloading server, a WAP gateway, and so on, and a gateway node 19. FIG. 1 shows also a network entity for providing content adaptation, a so-called content adaptation engine 20.

Device information, such as information on communication device capabilities or preferences of a device user or other such device related information, may be stored in a subscriber information database 17. The subscriber information database may locate in an intelligent edge or in another appropriate network entity or be a separate network entity as shown in FIG. 1. In an embodiment, terminal information may be stored in another appropriate network element, such as the gateway node 16, as will be explained below. In an embodiment, the subscriber information database 17 may include only an identification indication of a communication device relating to a user, such as the type of the device, for example Nokia 6600. Detailed description of the device, such as screen size, supported applications, and so on, may be stored in a separate database or directory. Such device information is common to many subscribers, in this case to all who have a similar Nokia 6600 device.

In an embodiment, an operator of the network may set device information in the subscriber information database. In an embodiment, a subscriber may be allowed to set device information in the subscriber information database using an operator portal in the Internet through which information may be reflected to the subscriber information database. To keep the subscriber information database updated, any new device information may be reflected from the portal to the subscriber information database without delays.

In an embodiment, a trusted terminal platform may be used that signals the device information into the subscriber information database 17 without active action from the subscriber. A signaling interface may be the WSI or another appropriate signaling interface.

In an embodiment, a gateway node 16 may receive device information from signaling of IMEISV (International Mobile Station Equipment Identity and Software Version Number). The IMEISV is composed of elements of decimal digits. The elements are: Type Approval Code (TAC), having a length of 6 digits; Final Assembly Code (FAC), which identifies the place of manufacture/final assembly, 2 digits; Serial Number (SNR), which is an individual serial number uniquely identifying each equipment within each TAC and FAC, 6 digits; and Software Version Number (SVN), which identifies the software version number of the mobile equipment, 2 digits.

In an embodiment, a gateway node 16 may receive device information from signaling of user data, such as User-Agent or UAProf (User Agent Profile). Both the UAProf and the User-Agent are typically sent by the communication device when establishing a connection or requesting a data service, e.g. in connection with MMS, WAP, browsing and downloading.

The gateway node 16 may store the device information. In an alternative, the gateway node 16 may forward the device information to be stored in another network entity, such as in the subscriber information database 17 or nodes providing service control functions, such as a standalone policy control server. When the gateway node forwards the device information, a new information element may be introduced in a protocol message. Appropriate protocols may comprise, but are not limited to, Diameter, COPS (Common Open Policy Service) and LDAP (Lightweight Directory Access Protocol).

In an embodiment, the content adaptation engine 20 or another external entity, such as a standalone policy server, a network element monitoring traffic (e.g. traffic analyzer, content analyzer), or a GGSN, may receive or obtain device information. The external entity may provide the device information to the gateway node 16 when needed.

Device information may comprise information on device capabilities, device type, services and protocols supported by the device, and so on. The purpose of this type of device information is to enable correct content processing, such as content adaptation or screening. In other words, the terminal information may enable appropriate service policy to be applied to the IP traffic coming from and going towards a given terminal. In an embodiment, a service policy relating to a given terminal type may be stored in a network node. When information on the given terminal type becomes available to the node, the node uses terminal information as a search key to identify the correct content processing to be applied. The node can be a standalone policy server in which case the node sends an identified service policy to a policy enforcement point. The correct content processing will be applied in the policy enforcement point. In another embodiment, the network node can be the content processing unit itself.

Device information stored in a network entity may be used in a gateway node, in an intelligent edge, or in another entity, such as in a content adaptation engine. Device information may be used for authorization, e.g. when indicating services allowed within an access point. Furthermore, device information may be used for policy control decisions, e.g. to decide whether a PEP or which of available PEPs should be used and to indicate the device information to the PEP. Appropriate policy control rules, such as charging rules, QoS rules, traffic filtering rules, rules for chained service selection and chained service component specific rules may be set.

Furthermore, device information may be used for content inspection and virus scanning. The content inspection and the virus scanning may benefit from the device information, as viruses and malicious content may be specific to an operating system of a device and to applications the operating system is running. The device information may limit the content inspection or virus scanning to elements relevant to the device in question. For example, if a communication device is known to have a certain vulnerability, inspection may go through the application included in the content, such as in an MMS message, and make sure that the known vulnerability is not exposed. For example, a Java application is sent to a mobile terminal and that particular type of mobile terminal is known to crash if a Java OpenPhoneBook function is called. The inspection will make sure that such function is not included in the sent Java application. In this example, the inspection shall be done only for that particular type of mobile terminal.

FIG. 2 shows a flow chart illustrating an embodiment of the invention. In step 300, a first network entity, such as a gateway node, an intelligent edge or a content adaptation engine, is provided with device information relating to a communication device intended to be a receiving or sending device for messages. In step 302, content to be delivered to or from the communication device is received in the first network entity. In step 304, delivery of the content is controlled based on the capabilities of the terminal. Controlling may comprise various measures as will be explained in the following.

In an embodiment, the first network element may receive the device information from signaling, such as signaling the IMEISV, the User-Agent or the UAProf, as was explained above. In an embodiment, the first network element may receive the device information from a second network element, such as a subscriber information database or a trusted terminal platform.

In an embodiment, the content is decomposed into content elements. The controlling step may comprise inspecting the content elements for suitability for the terminal. For example, it may be inspected if the content comprises elements suspected to be malicious, undesirable, incompatible or virus for a receiver device. In an embodiment, the elements suspected to be malicious, undesirable, incompatible or virus for the device may be stored or quarantined in a network side storage. The receiver may fetch these elements from the storage, if desired.

Preferably, the step of controlling is performed simultaneously with an operation adapting the content to fit with capabilities of the communication device, such as the content adaptation operation described above. The content comprising both content (e.g. image) and application (e.g. Java application), may thus be inspected at the same time than the content is adapted in function of the receiving device.

Controlling may be performed for any element of the content to be delivered, in particular of an application that is executable in the communication device. Examples may include elements of Java, Mobile Station Application Execution Environment (MExE), Visual Basic or other language applications. Examples may also include elements of Symbian, Intelligent Software Architecture (ISA), Windows, Smartphone, Binary Runtime Environment for Wireless (BREW), Linux or other operating system applications. Examples may also include elements of multimedia or instant messaging, email or chat service message.

The controlling step may further comprise modifying the content elements, which were found to be non-suitable for the receiving communication device, in order to make the non-suitable content elements suitable for the device. The modifying may comprise deleting the content elements, which may be considered malicious, undesirable, incompatible or virus elements for the device in question. In an embodiment, the modifying may comprise transforming the content elements into a non-malicious format in accordance with the information on capabilities of the device. Controlling may further comprise composing a deliverable content entity by including the content elements found to be suitable and the content elements modified into suitable for the device. When at least one of the content elements is found to be suitable or made suitable for the terminal, the content entity including said suitable content elements may be delivered to the receiving communication device.

In an embodiment, the communication device may be informed about the inspection performed, including about content screening and any changes that have taken place. It may be the network entity, which performed the inspection, that inform the communication device via any appropriate other nodes.

Embodiments of the invention may be performed by means of a computer program comprising program code means.

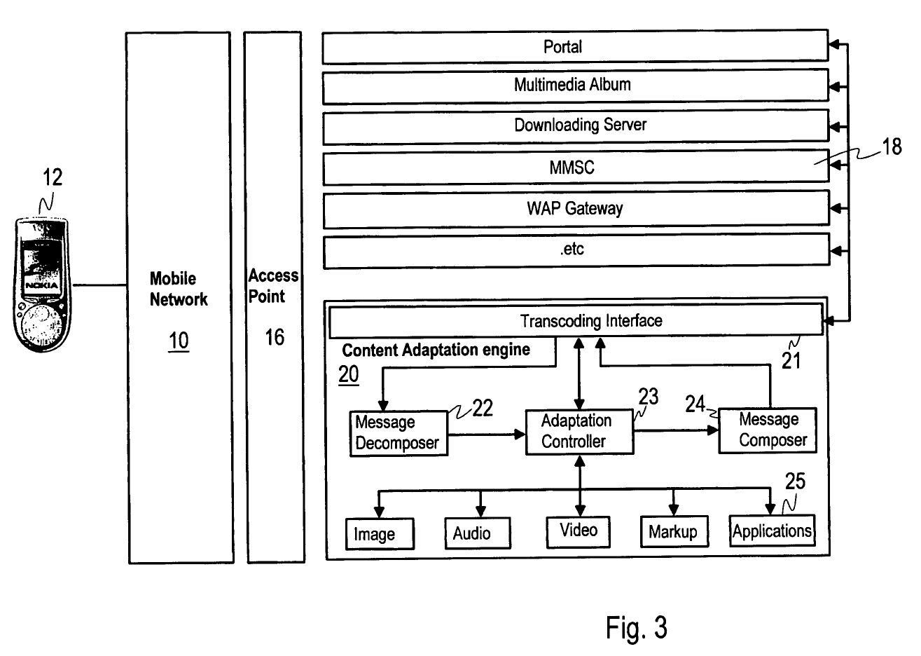

FIG. 3 shows an embodiment of the invention. Before delivering content, such as an MMS message, or another message, content or an application to a receiving communication device, the content may be sent from the sending device 12 to an inspecting entity, such as the content adaptation engine 20. Other inspecting entities may include, but are not limited to, an intelligent edge and a gateway node. The content adaptation engine is used as an example in this embodiment. Other examples may comprise, but are not limited to, a content screening engine.

In the content adaptation engine 20, the content, comprising data content and applications, is decomposed in a message decomposer 22. Elements of the content 25 may be analyzed and adapted, if needed, by transcoding, scanning and inspection under a control of an adaptation controller 23.

Analyzing the content may be performed based on content adaptation policies provided in the content adaptation engine, for example, via a transcoding interface 21. Policies and device information may be provided with the content adaptation engine using other appropriate means, for example a policy and device information interface or the like. The content adaptation policies may comprise device information on sending and receiving parties, such as capabilities of a sending device and of a receiving device, subscriber preferences, and so on. The device information may be collected and received in the content adaptation engine 20 as described in the above embodiments or by another appropriate way. A subscriber may set in the content adaptation engine, for example through the transcoding interface 21, the subscriber preferences, for example activate or deactivate virus scanning.

The content adaptation policies may define that content or application should be deleted immediately, for example, all Java applications should be deleted. Deletion may be done in an appropriate part of the content adaptation engine 20, for example in the adaptation controller 23.

Furthermore, the content adaptation policies may define whether or not the receiving device supports an application or content type. In the content adaptation policies, it may be set, for example, “no Symbian support”.

If a message, content or an application, e.g. Symbian or Java MIDlet application, was not deleted and the content adaptation policies indicated that the content is supported or simply does not indicate that the content is not supported, the content may be passed to further entities, such as the message decomposer 22 and adaptation controller 23. These further entities may perform a thorough screening for the entire content to be delivered. The screening may comprise verifying whether a function contained in the content is allowed for the sending and receiving parties. The content screening may further comprise inspecting the content, comprising data content and applications, for example, for viruses or other malicious elements. The screening may be performed for all types of applications and content, such as Java and Symbian applications, as well as media content, e.g. images or music.

As an example, Windows PC virus scan engines search files for hundreds or thousands of virus signatures to detect the infected ones. Symbian viruses may use a completely different set of signatures. Using device and software information, as proposed in embodiments of the invention, may optimize the screening to use only the relevant subset of all signatures.

In a preferred embodiment, the content screening is carried out in the content adaptation engine or another network entity performing content adaptation and/or screening. In an embodiment, the content screening may be performed in a separate network entity. In the content screening, the device information of the receiving or sending communication device is taken into account. As described above, a type of content may be malicious for some types of devices, but not harmful to other types of devices. Uplink screening, i.e. screening of the content sent from a device, may be essential to prevent an infected device from spreading the virus or other harmful content to other devices.

Once all desired operations, such as content adaptation, transcoding, inspection, and so on, are performed for the different elements of the content, the content may be re-composed or a deliverable content entity may be composed in a message composer 24. The re-composed or composed deliverable content entity may then be returned to a delivering network entity 18 for delivering to an intended recipient. For example, an MMS message, which has been inspected as described above, may be returned to the respective multimedia messaging service center (MMSC) to be delivered to the intended receiving device.

The same approach for screening and content inspection may be applicable and used by other services in the network, such as portals, gateways, e.g. a WAP gateway, proxies, e.g. a proxy for mark-up content or single media objects.

Embodiments of the invention may protect malicious, undesirable, incompatible and virus applications and content from reaching mobile devices or terminals. The implementation may be improved, for example latency in delivering content may be reduced, by performing content and application inspection as a part of content adaptation and/or transcoding operation and performing content inspection based on the receiving device capabilities and information. A common interface for content adaptation and application and content inspection may be provided. This may reduce signaling and separate entities in a network.

Furthermore, utilizing device information may also improve various other functions in the delivering network elements. Content delivery and services may be tailored for device capabilities. Using automatic detection of device information, such as signaling the IMEISV, the User-Agent or the UAProf, may provide a convenient way of obtaining device information.

Although the invention has been described in the context of particular embodiments, various modifications are possible without departing from the scope and spirit of the invention as defined by the appended claims. It should be appreciated that whilst embodiments of the present invention have mainly been described in relation to mobile communication devices, such as mobile terminals, embodiments of the present invention may be applicable to other types of devices that may access communication networks. Furthermore, the communication system may be any appropriate communication system, even if reference has mainly been made to mobile communication systems.

1. A method for controlling content communication between a communication device and another communicating party in a communication system, the method comprising:
providing a first network entity with device information relating to a communication device;
receiving in the first network entity content to be delivered to or from the communication device; and
controlling delivery of the content based on the device information.

2. A method according to claim 1, wherein the step of controlling comprises decomposing the content into content elements and inspecting the content elements for suitability for the communication device.

3. A method according to claim 2, wherein the step of controlling comprises inspecting the content elements for elements suspected to be malicious, undesirable, incompatible or virus for the device.

4. A method according to claim 3, further comprising storing the elements suspected to be malicious, undesirable, incompatible or virus for the communication device in a network side storage.

5. A method according to claim 3, wherein the step of controlling comprises inspecting the elements of an application that is executable in the communication device.

6. A method according to claim 5, wherein the step of controlling comprises inspecting the elements of a Java, Mobile Station Application Execution Environment or Visual Basic application.

7. A method according to claim 5, wherein the step of controlling comprises inspecting the elements of a Symbian, Intelligent Software Architecture, Windows, Smartphone, Binary Runtime Environment for Wireless or Linux application.

8. A method according to claim 3, wherein the step of controlling comprises inspecting the elements of a multimedia or instant messaging, email or chat service message.

9. A method according to claim 2, wherein the step of controlling comprises composing a deliverable content entity by including the content elements found to be suitable for the communication device in the step of inspecting.

10. A method according to claim 1, wherein the step of controlling comprises performing said controlling step simultaneously with an operation adapting the content to fit with capabilities of the communication device.

11. A method according to claim 1, wherein the step of controlling comprises decomposing the content into content elements,
inspecting the content elements for suitability for the communication device, and
modifying the content elements found to be non-suitable for the communication device to make non-suitable content suitable for the communication device.

12. A method according to claim 11, wherein the step of controlling comprises composing a deliverable content entity by including the content elements found to be suitable and the content elements modified into suitable for the communication device.

13. A method according to claim 1, wherein the step of controlling comprises inspecting the content in association with the communication device information for authorizing a service or controlling a service policy.

14. A method according to claim 13, further comprising a step of authorizing the service.

15. A method according to claim 14, wherein the step of authorizing the service comprises determining whether the communication device is allowed to use an access point, or which services are allowed for the communication device within the access point.

16. A method according to claim 14, further comprising a step of controlling the service policy comprises deciding service control rules to be applied to the communication device.

17. A method according to claim 16, wherein the step of deciding the service control rules comprises selecting charging rules, quality of service rules, traffic filtering rules, rules for chained service selection or chained service component specific rules.

18. A method according to claim 1, wherein the step of providing comprises receiving the device information from signaling an international mobile station equipment identity and software version number or the user-agent or the user agent profile.

19. A method according to claim 1, wherein the step of providing comprises receiving the device information from a second network entity.

20. A method according to claim 19, wherein the step of receiving the device information from the second network entity comprises receiving the device information from one of a trusted terminal platform, a subscriber information database or the communication device.

21. A method according to claim 2, wherein the step of controlling comprises informing the communication device about the inspecting step.

22. A computer program, embodied on a computer readable medium, for controlling content communication between a communication device and another communicating party in a communications system, the computer program controlling a computer to perform the steps of:
providing a first network entity with device information relating to a communication device;
receiving, in the first network entity, content to be delivered to or from the communication device; and
controlling delivery of the content based on the device information.

23. A network entity configured to:
obtain device information relating to a communication device;
receive content to be delivered to or from the communication device; and
control delivery of the content based on the device information.

24. A network entity according to claim 23, further configured to decompose the content into content elements and to inspect the content elements for suitability for the communication device.

25. A network entity according to claim 24, further configured to inspect the content elements for elements suspected to be malicious, undesirable, incompatible or virus for the communication device.

26. A network entity according to claim 25, further configured to store the elements suspected to be malicious, undesirable, incompatible or virus for the communication device in a network side storage.

27. A network entity according to claim 26, further configured to inspect the elements of an application that is executable in the communication device.

28. A network entity according to claim 27, further configured to inspect the elements of a Java, Mobile Station Application Execution Environment or Visual Basic application.

29. A network entity according to claim 27, further configured to inspect the elements of a Symbian, Intelligent Software Architecture, Windows, Smartphone, Binary Runtime Environment for Wireless or Linux application.

30. A network entity according to claim 25, further configured to inspect the elements of a multimedia or instant messaging, email or chat service message.

31. A network entity according to claim 23, further configured to compose a deliverable content entity by including content elements found to be suitable for the communication device.

32. A network entity according to claim 23, further configured to perform an operation adapting the content to fit with capabilities of the communication device simultaneously with controlling the delivery.

33. A network entity according to claim 23, further configured to decompose the content into content elements,
to inspect the content elements for suitability for the communication device, and
to modify the content elements found to be non-suitable for the communication device to make non-suitable content suitable for the communication device.

34. A network entity according to claim 33, further configured to compose a deliverable content entity by including the content elements found to be suitable and the content elements modified into suitable for the communication device.

35. A network entity according to claim 23, further configured to inspect the content in association with the device information for authorizing a service or controlling a service policy.

36. A network entity according to claim 35, further configured to authorize the service.

37. A network entity according to claim 36, further configured to authorize the service by determining whether the communication device is allowed to use an access point or which services are allowed for the communication device within the access point.

38. A network entity according to claim 35, further configured to control the service policy comprising deciding service control rules to be applied to the communication device.

39. A network entity according to claim 38, wherein the service control rules comprise charging rules, quality of service rules, traffic filtering rules, rules for chained service selection or chained service component specific rules.

40. A network entity according to claim 23, further configured to receive the device information from signaling a international mobile station equipment identity and software version number or a user-agent or a user agent profile.

41. A network entity according to claim 23, further configured to receive the device information from a second network entity.

42. A network entity according to claim 41, further configured to receive the device information from one of a trusted terminal platform, a subscriber information database or the communication device.

43. A network entity according to claim 24, further configured to inform the communication device about the inspection.

44. A network entity according to claim 23, comprising one of a gateway node, an intelligent edge or a content adaptation engine.

45. A network entity comprising:
means for obtaining device information relating to a communication device;
receiving means for receiving content to be delivered to or from the communication device; and
control means for controlling delivery of the content based on the device information.

46. A second network element configured to collect and store communication device information and to provide the communication device information with a first network entity.

47. A second network element according to claim 46, comprising one of a trusted terminal platform or a subscriber information database.

48. A second network element according to claim 46, further configured to collect and store an identification indication of the communication device and to obtain full communication device information from a separate database.

49. A communication system configured to:
obtain device information relating to a communication device;
receive content to be delivered to or from the communication device; and
control delivery of the content based on the device information.

50. A communication system according to claim 49, wherein the device information is configured to be received from signaling an international mobile station equipment identity and software version number or a user-agent or a user agent profile.

51. A communication system according to claim 49, wherein the device information is configured to be received in a first network entity from a second network entity.

52. A communication system according to claim 49, wherein the second network entity is configured to collect and store the device information.

53. A communication system according to claim 51, wherein the content to be delivered is configured to be received in and the delivery of the content is configured to be controlled in the first network element.

54. A system for controlling content communication in a communication system, the system comprising:
providing means for providing a first network entity with device information relating to a communication device;
receiving means for receiving in the first network entity content to be delivered to or from the communication device; and
controlling means for controlling delivery of the content based on the device information.
